(19) United States
(12) Patent Application Publication
(10) Pub. No.: US 2008/0163092 A1
(43) Pub. Date: Jul. 3, 2008

(54) ONE STOP INSTALL, UN-INSTALL, AND UPDATE OF SOFTWARE PRODUCTS

(75) Inventor: Siddhartha Ashok RAO, Sandhausen (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 11/618,821

(22) Filed: Dec. 30, 2006

(51) Int. Cl. G06F 9/445; G06F 3/048

(52) U.S. Cl. 715/771; 717/176

(57) ABSTRACT

A system and method is provided for effecting an installation, uninstallation, and/or an update of one or more software products and/or components with a single action. A distribution server may have an installation toot to read the installation server databases on both the distribution server and a workstation to determine products and/or product components resident on the server and workstation. The installation tool may read and display information associated with the found products and/or product components. Such information may include installed, uninstalled, update available, version number, etc. Via a user interface, a user may select and/or deselect products and product components desired for installation, uninstallation, and/or updating. All of the users selections/deselections may be effected in an essentially simultaneous manner.

### BACKGROUND

A business system may include a variety of software applications that can be installed from a distribution server to a workstation or end user computing device to allow users to perform operations within the business system. Each software application generally includes an installation application, which when run on a computer configures the software application on the computer. Since a business system may include a large number of software applications, many such installations may be required to properly configure a workstation computer before it can be used in the business system. In addition, when a previously-installed software application is to be replaced by an updated version of the application, the previous version often must be removed from the computer prior to installation of the new version. And, software applications may rely on other applications, requiring the applications to be installed in a particular order or priority.

### BRIEF DESCRIPTION OF THE DRAWINGS

FIG. 1 shows an embodiment system according to the present invention.

FIG. 2 shows an exemplary database system according to the present invention.

FIG. 3 shows an exemplary database system according to the present invention.

FIG. 4 shows a system according to the present invention,

FIG. 5 shows an embodiment according to the present invention.

FIG. 6 shows a flowchart of an exemplary embodiment according to the present invention.

FIG. 7 shows a flowchart of an exemplary embodiment according to the present invention.

FIG. 8 shows an exemplary system according to the present invention.

FIG. 9 shows an exemplary user interface according to the present invention.

FIG. 10 shows an exemplary user interface according to the present invention.

### DETAILED DESCRIPTION

Embodiments of the present invention provide an administrator or a user having access rights to effect the installation, uninstallation and/or updating of products and/or product components on a users computing device or workstation. A user may also request and obtain pre-configured installation packages containing the new products for essentially simultaneous installation.

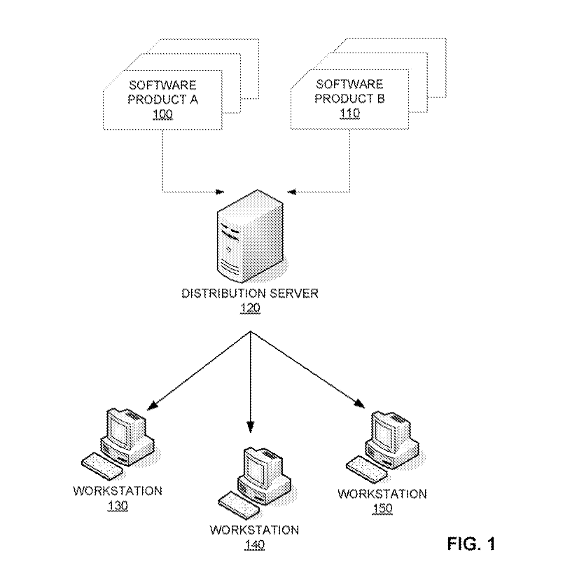

As illustrated in FIG. 1, in embodiments of the present invention, an installation server or distribution server 120 may be used not only as a distribution point for distributing software 100, 110, e.g., a front end software, to one or more workstations 130, 140, 150 or other end entities, but also as the recipient of software products and parts thereof.

In embodiments of the present invention, an administrator or other entity may use the same installation software to install products and/or product components on a workstation for past, present, and/or future products. Throughout this specification, the administrator or other entity—which may include an automated function/machine, a person, and authorized person, etc.—will be referred to as “the administrator.” This term is not meant to limit the type of entity who can effect such actions. Embodiments of the present invention allow for the administrator to add new products or parts thereof to a workstation or other computing device and remove undesired products or components thereof. Throughout this specification, the term product will be used to indicate a software product or application, and/or component thereof. Throughout this specification, the term distribution or installation server may refer to a computing device, a computer readable medium/media, and/or a network-accessed site. In further embodiments, the new product(s) to be added may be administrator-configurable, and may be made available for installation on user workstations or other computing devices.

In embodiments of the present invention, a database is split on hierarchical, location, and/or content. A database split on a hierarchical level provides for an installation server database which is the default database loaded by a distribution server, and at least one product database. The at least one product database, or component(s) is associated with the software product. In embodiments of the present invention, when a product is added to a workstation, an installation server database associated with that product is loaded by default. That installation server database then may enlist other product databases to be loaded by the workstation. The loading of a product database by the workstation involves copying the product(s) and/or product component(s) to the workstation and registering the new product database with the installation server database on the workstation. The installation server database indexes the subsequently added products/components.

In embodiments of the present invention, a product is comprised of one or more components. A component, or installation component, may include file(s) registry key(s), script, etc. An action can install a component. A UI layer, for example, may be a collection of actions. Installation of a component effects an installation of everything included in that product component, which may include multiple files and registry keys. Likewise, uninstallation of a component effects an uninstallation of everything included in the product component. In an embodiment, when a request is made to delete a product, a check is done to see if an installation component of the product is used by another product, and if not the product may be deleted. An administrator may or may not request to remove a component of a product, but rather the product in its entirety.

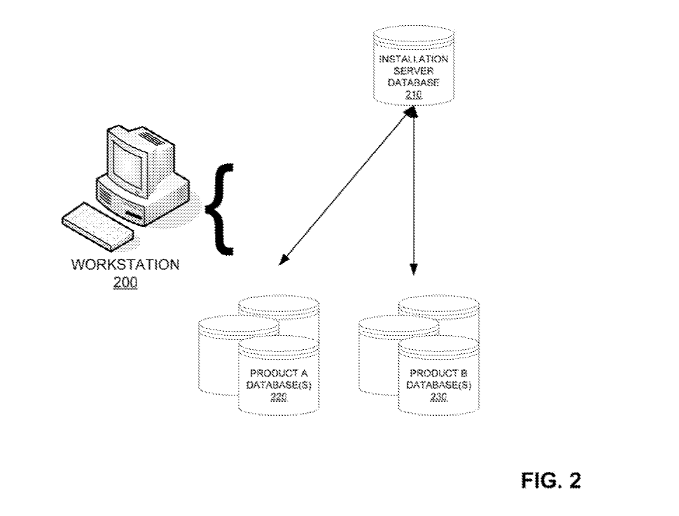

FIG. 2 shows an exemplary database system of a workstation 200. The workstation contains an installation server database 210 which indexes each of the product A database(s) 220, and product B database(s) 230.

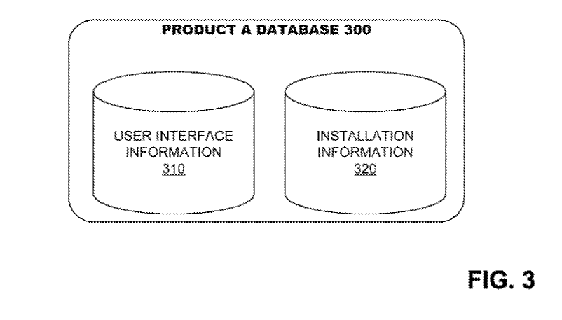

FIG. 3 shows an exemplary database of a product A database 300. The product A database 300 is split on user interface information 310 and installation information 320. This architecture may allow for ease and flexibility in managing the product databases in the workstation.

In embodiments of the present invention, an administrator can receive a new product via, for example, the Internet, a company Intranet, local area network (LAN), wide-access area network (WAN), a hardwired connection, a computer readable medium such as a DVD, CDROM, disk, and/or flash memory. The administrator may then start the installer's server management tool. The administrator is then able to select “add” or similar function, and add the desired new product and/or component to the administrator's intended destination. The destination may have several products existing on it at the time. The effect of adding the new product to the workstation from the distribution server involves a copying by the installers server management tool of the product components, including product database(s) associated with the product. Further, the installer's server management tool registers the product database(s) with the installation server database on the workstation.

In embodiments of the present invention, the administrator or user may wish to remove a product or part thereof from the workstation. To remove a product or part thereof, i.e., a component, the administrator or user must remove the indexing of the product components/databases on the installation server database. Upon removal, it is as if the product does not exist on the workstation even though it is essentially present. A user and the administrator will not see this product in the user interface generated by the installation tool displaying the contents of installation server database. Further, an administrator or the user may remove completely the product components/databases from the workstation as well.

In embodiments of the present invention, a product may be shipped with a database. The database may contain pre-configured package installation data for the product. The database may first be registered by the servers installation server database, and then may be communicated to the workstation's installation server database.

In the workstation, there is a database, e.g., the installation server database, which is made hierarchically superior to the other resident databases. The installation server database indexes and reads the other databases. When a new product is deployed to the workstation, e.g., via a computer, the act of adding products involves getting the database from the new product location onto the workstation and indexed by the hierarchically first database.

In further embodiments, a notepad text file may keep information concerning the products to be installed, uninstalled, and/or updated,

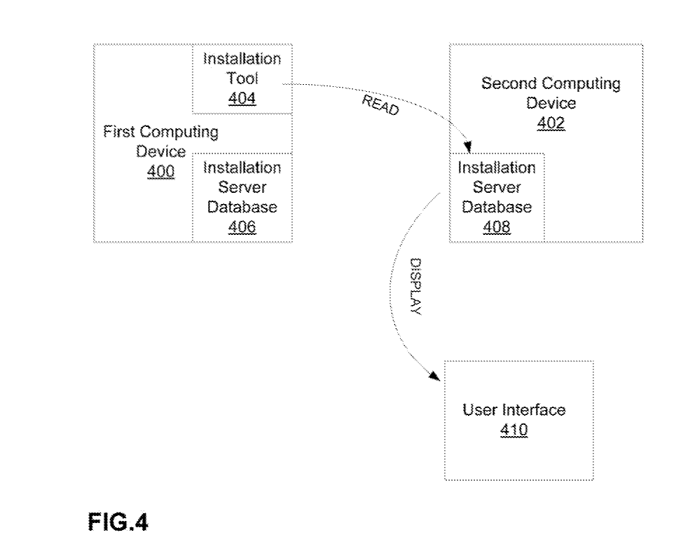

FIG. 4 shows a system having a first computing device 400 and a second computing device 402. The first computing device 400 may have a resident installation tool 404. The first computing device may be, for example, a distribution server. The second computing device may be, for example, a workstation. The installation tool 404 of the distribution server may read the installation server databases 406, 408 of both the distribution server and the workstation. The installation tool works on the workstation via, for example, a hardwire connection, a network a medium, a CDROM, a DVD, and/or a flash memory. The results of a reading by the installation tool 404 may be displayed in a graphical user interface 410 to a user and/or administrator. The results may indicate what products and product components are located on the distribution server and the workstation. A user may then, via the graphical user interface 410, select deselect, and/or neither select or deselect the products and/or product components displayed. A selection may indicate a desire for installation or upgrade of the selected product and/or product component. A deselection may indicate a desire for an uninstallation of the selected product and/or product component. The installation tool may also read information associated with each product and/or product component. Such information may indicate which device has the displayed product and/or product component installed and/or uninstalled. Such information may also indicate a version of the displayed product and/or product component. Other such information may be “modified” and “location.” Upon the selections and deselections of the user or administrator, with a single action of accepting the choices made on the interface, the desired installations, uninstallations, and updates occur essentially simultaneously on the one or more products and/or product components involved.

In embodiments of the present invention, an installation of a product and/or product component on the workstation involves copying the product component(s) onto the workstation and indexing the product component(s) and associated information in the installation server database of the workstation.

In embodiments of the present invention, before a product/product component is installed on the workstation, the installation tool of the server may analyze whether the product/product component requires another indexed product/product component in the installation server database of the first computing device, and if necessary, then both the product/product component and the required indexed product/product component are installed on the workstation. In embodiments of the present invention, to uninstall a product/product component on the workstation, the product/product component must be removed from the index of the installation server database on the workstation. In addition, the product/product components desired for uninstallation may be removed from the workstation. Before an uninstallation takes place, the installation tool analyzes whether the product/product component is necessary to another indexed product/product component in the installation server database of the workstation. If necessary, then the product/product component is not uninstalled. If not necessary, then the product/product component is uninstalled. An additional graphical user interface may be used here to ask the user or administrator if they would like for the product/product component to be removed from the workstation as well.

In embodiments of the present invention, an update or modification of a product or product component may be requested by the user or administrator. Such modification may entail that the installation tool of the distribution server analyze the version information of the relevant product/product component on the workstation against the version information of the available update. If the modification or update is a newer, and desirable version, then the product/product component is modified accordingly by copying the product/product component from the distribution server or other location to the workstation and updating the associated version information of the product/product component in the installation server database on the workstation. The installation tool of the distribution server may observe whether the older version of the product/product component is necessary for another product/product component. And, if so, the user or administrator may be prompted for further instruction.

In embodiments of the present invention, the graphical user interface may display a result of a differential analysis of the installation server databases of the distribution server and the workstation(s). The result may be a listing of the product components available from the server and the product components already installed on the workstation, among other things. The product components may belong to one or more software products.

The graphical user interface may include a list, a checklist, balloons, buttons, and/or dialog opportunities to make a selection of products/product components. Further, in embodiments herein, the first computing device may be at least one of a distribution server, an installation server, a computer, a handheld computing device, a medium, a network site, multiple computing resources, a DVD, a CDROM, and a flash memory. The second computing device may be at least one of a user workstation, a computer, a handheld computing device, a medium, a network site, multiple computing resources, a DVD, a CDROM, and a flash memory.

Installation is a database oriented activity. The changes to the state of an installed product is reflected in an installation server database. In embodiments of the present invention, the distribution server may provide for an abstraction of data management from the user interface and installation tools. The Data Manager of the distribution server may isolate the database syntax from the installation feature(s) implementations.

In embodiments of the present invention, the installation process may be synchronized by a visual basic script. It is appreciated here that other available programming languages may be used. Visual Basic is used here for illustrative purposes. The setup start application loads a script host that parses and executes the visual basic script. The script then uses the engine objects and tools to perform various installation activities.

In embodiments of the present invention, multiple products may be handled by a distribution server. Further, sharing of products and/or their components may be effected across products. Further, user interface data is isolated from the installation data. Further, the database having a split architecture may be in an easier to read and understand format, possibly allowing more users to configure product installations.

In embodiments of the present invention, the distribution server design may provide that the script has superior control over the user interface on a page by page basis. Further, the script may validate user input and react to the same immediately rather than wait for a wizard object to complete execution. Further, defining server internal and external installation actions allow for scaling of the functionality for future usage.

In embodiments of the present invention, there is an installation server database and a workstation database per product. When loaded, the default engine database is loaded first. Further, inter-dependency between products is recognized and may be indicated in the distribution server indexing installation server database. Some example engine classes include SetupEngine (instantiated by script), DataManager, DataExchange, SetupUIManager. The Data Manager, DataExchange and SetupUIManager are instantiated by the distribution server.

In embodiments of the present invention, the distribution database may also contain an uninstallation tool to remove software from the distribution database and/or other computers. The uninstallation tool involves reading and interpretation of the installation databases, providing options for partial uninstallment of components unnecessary for other component(s). Further, an administrator of the distribution server may delete products from the server, or empty the server. Authorization may be provided to another as well. Further, an automatic deletion of products and/or their components may be instituted on the distribution server.

In embodiments of the present invention, the processes create server and add product are a part of the deployment tools. Thus, once an installation server is created, the add product process may extend the functional scope of the server to one that can handle and distribute multiple products over a network.

In embodiments of the present invention, every product in an installation server has its respective installation information stored in its own product database(s) which is a part of the installation server database. The installation server database contains a collection of individual product databases, and also information pertaining to configured product packages in the installation server. The deployment tools may use the installation server database to perform server administration, et al.

In embodiments of the present invention, the installation server database may be comprised of smaller product databases. Interaction between the installation server database and the products available on the server is via, e.g., the server engine.

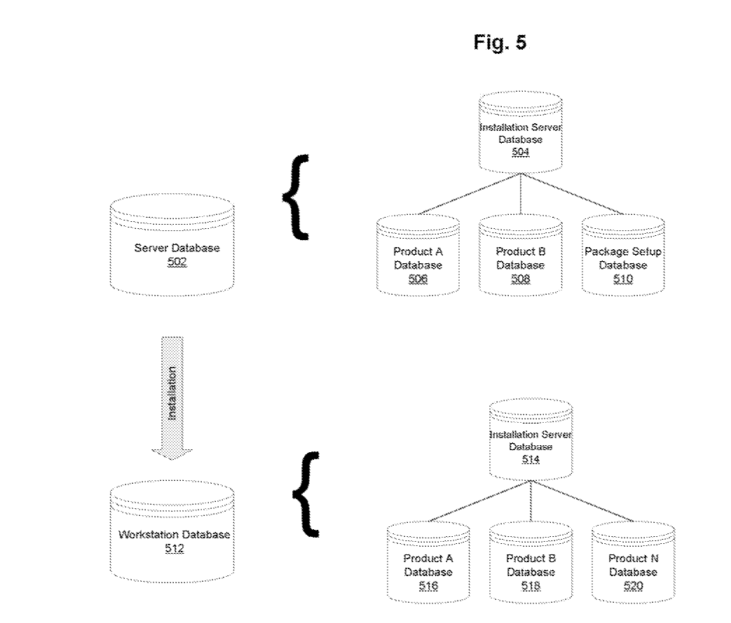

FIG. 5 shows an exemplary embodiment 500 of the transformation between, for example, a server location and a destination location, and the database hierarchies. The server database 502 has an installation server database 504 which is hierarchically superior to its associated product databases 506, 508, 510. The installation server database 504 identifies and indexes the product databases. A product database 506 may include installation information relevant to a first product component. Another product database 508 may include installation information relevant to a second product component. Another product database 510 may include installation information relevant to a package setup of the first and second product components.

The server database using deployment tools may be used to install software, e.g., the package of multiple products or parts thereof, on a workstation or other destination location. That is, information is transferred from the server database to the workstation database. The resulting workstation database 512 may contain a corresponding installation server database 514 which identifies and indexes a first product database 516, a second product database 518, and possible other product database(s) 520. Those databases include the location address of the workstation. In the course of the installation from the distribution server to the workstation, the installer engine may be required to convert information contained in the server database to a format suitable to the workstation tools before depositing the database on the workstation. Such conversions may include an interpretation of path names (e.g., change server location path name to a workstation location path name), variables (e.g., a variable tag to specify the relative path or other parameters of the installation), usage counts (e.g., an indication that a product or part thereof is required by other product(s) or part(s) thereof if installed), etc.

In embodiments of the present invention, an installation server database may indicate its equivalent workstation database. This may allow an administrator to keep track of which products or parts thereof are loaded onto which workstations. Further, this may allow for future updates, removals, and/or patches initiated by a distribution server.

In embodiments of the present invention, information contained in the installation server database is user interface information and product installation information. User interface information is, for example, information pertaining to the display of a product available for installation. User interface information may also be, for example, information pertaining to product component selection/auto selection/auto-deselection in the user interface. Product installation information is, for example, information regarding the product file(s) including paths, versions, etc. Further, product installation information also includes, for example, registration information for the product, data for the installer to configure product installations, etc. In embodiments of the present invention, the isolation of these two types of information provides for easy readability and changeability.

In embodiments of the present invention, a database is classified by type on the basis of the default installation server, or engine, database loaded by the server, and is categorized on the basis of its location. For example, an installation server database is a default database loaded by an installation software engine, and contains installation software relevant information and assists the server in identifying and locating product database(s). For example, a product database contains product installation information. It is appreciated that the databases may be maintained in various formats. For example, the database may be used in xml format which allows for a certain ease of readability, ease of data retrieval and insertion (with parsers readily available), and ease of distribution (due to compactness).

In embodiments of the present invention, an engine, or server, loads a respective installation server database on the basis of the context in which it has been started (e.g., distribution server or workstation). The content of the database tags inform the engine, or server, of the product(s) available by presenting the location of their respective product database(s). A server, or engine, may identify the contents of a database tag as belonging to a specific product, thus, the tag provides for a structural organization of installation data.

In embodiments of the present invention, the distribution server presents information to a user (i.e., administrator) via a user interface, and performs deployment, patch, or uninstallation activities. The user interface features allow for product listing, subcomponent of product listing, auto-selection of downward components (i.e., selection of parent provides for automatic selection of child), dependency selection, and package creation/information.

In embodiments of the present invention, for example, the implementation of user interface hierarchy may be achieved through nested <Contains> xml-tags. The higher-level tag becomes the parent of the tags below it. And, component installation order is affected by <Requires> xml-tags which provide that required components are installed before the components or products that require them. The user interface tree may be constructed using <contains> xml-tags.

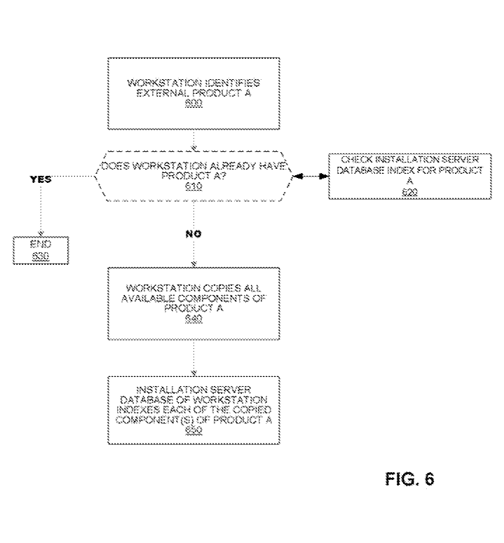

FIG. 6 shows a flowchart involving adding one or more products to a workstation from other locations. The other locations may include networked resources, a portable medium, another server, etc. The installation server database identifies an external product A which it may wish to load 600. The workstation may then proceed with checking whether it already contains product A or part thereof or if there are any conflicts involved in adding product A 610. The installation server database which indexes all of the product databases is checked for product A 620, instead of checking each individual product databases. If the workstation already has product A, then the installation server database does not act further with respect to obtaining the product A 430. In this situation, an alert may be sent to the user or administrator, or a notation concerning the attempt may be logged in a table. If the workstation does not already have product A 610, then the workstation may copy all available components of product A from the source/location 640. The installation server database of the workstation indexes each of the copied components/databases of product A 650. This indexing may be automatically triggered when product components are being installed on the workstation.

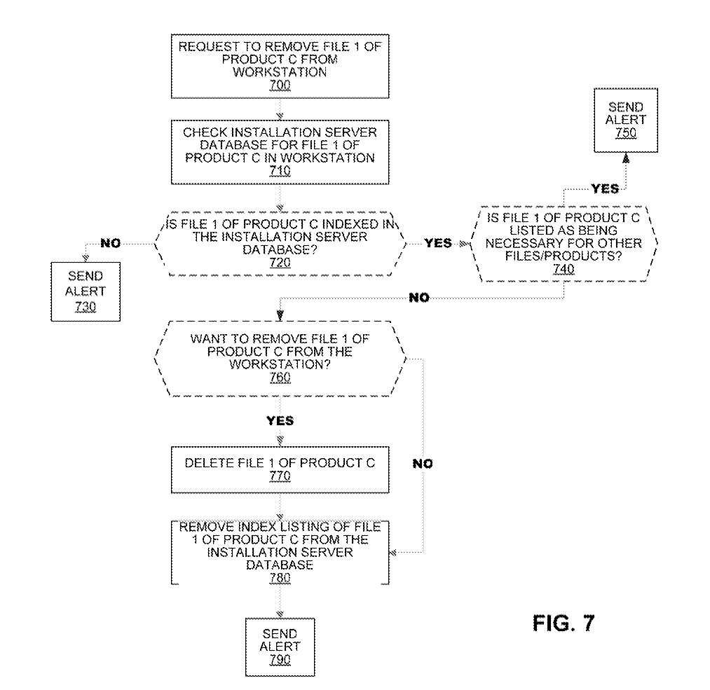

FIG. 7 shows a flowchart involving removing one or more products from a workstation. A request to remove a product from the workstation 700 may trigger a check of the installation server database of the workstation for that product 710. If the product is not indexed in the installation server database 720, then an alert may be sent to the user or administrator or a notice logged which indicates that the product is not indexed on the workstation. If the product is indexed, then a check is done whether the product or component thereof, is necessary for other product(s) to function as desired 740. If the product is necessary, then an alert may be sent to the administrator or user 750, or a notice is logged to indicate that the product will not be removed without, e.g., additional confirmation, in view of the dependence of another product. If the product is not necessary for other product(s) on the workstation, then the user or administrator may be queried whether he would like to remove the product completely from the workstation 760. If yes, then the product is deleted from the workstation 770, and removed from the indexed listing on the installation server database 780 on the workstation. If the user or administrator does not wish to also remove the product from the workstation, then the product is deleted from the indexed listing on the installation server database 780 of the workstation. Additionally, an alert or communication may be sent to the user or administrator or to a log file to indicate the removal of the product.

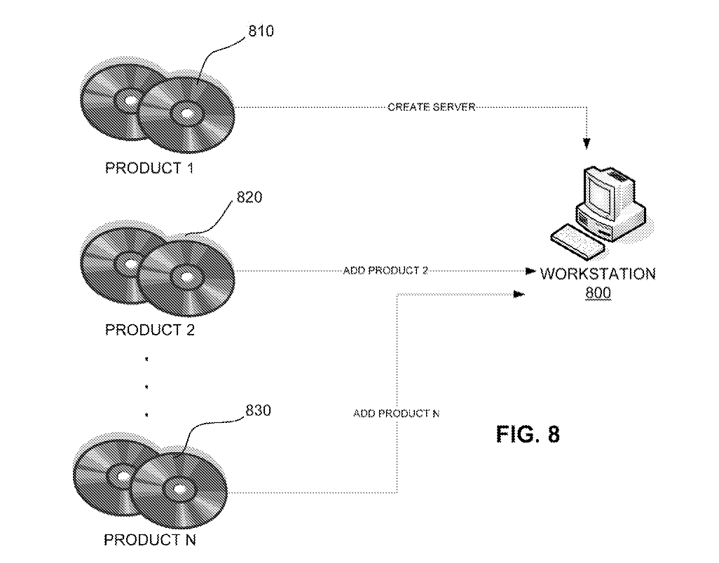

FIG. 8 shows another system embodiment of the present invention. Multiple software products 810, 820, . . . 830, may be added to a workstation 800 essentially simultaneously. The first product 810 added to the workstation creates the installation server database which indexes itself and all of the subsequently loaded products 820, 830. A server creation tool may be used to create the installation server database.

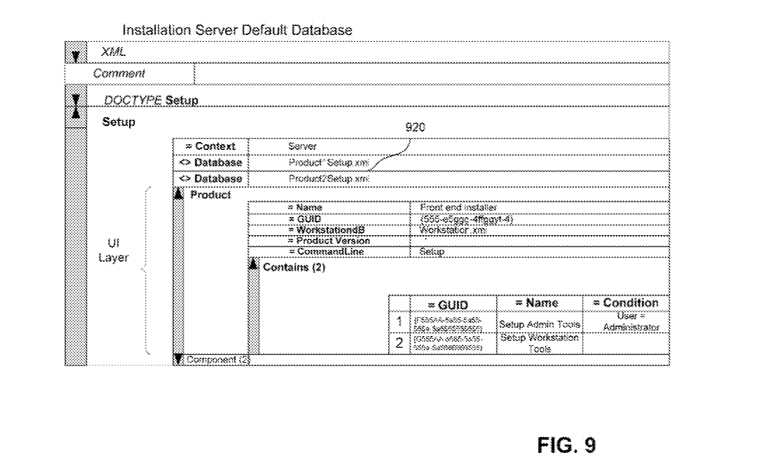

FIG. 9 shows an example user interface which indexes the products, the product GUID (globally unique identifier), etc. Here, the data manager on the workstation keeps track of the databases to be loaded 920.

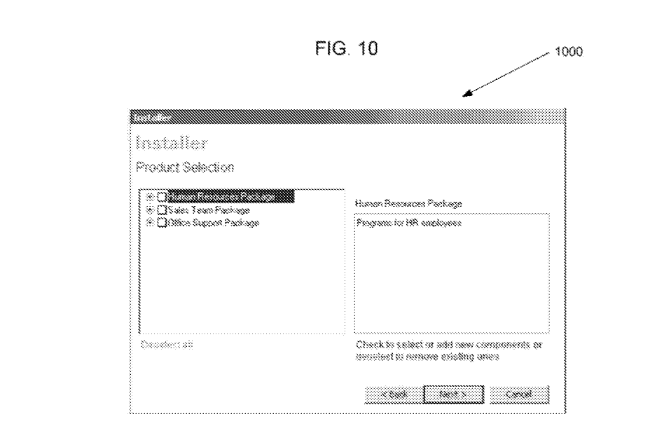

FIG. 10 shows a sample graphical user interface 1000 having check boxes to allow a user to select and/or deselect products and/or product components according to embodiments of the present invention.

Software applications, or programs, may be stored in a business system. The software applications may be stored, for example, in a distribution server in communication with other servers and workstations in the business system. The applications may be stored and accessed using various storage devices and computer systems available. An administrator may access the software applications in the business system.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A system, comprising:
a first computing device;
a second computing device; and
an installation tool, the installation tool being located on the first computing device,
wherein in response to a request to do at least one of install, uninstall, and modify, a software product component on the second computing device, the installation tool executes on the second computing device, reads any installation server databases on the first and second computing devices to determine product components and their associated information, and carries out the request to do at least one of install, uninstall, and modify.

2. The system of claim 1, wherein the request to do at least one of install, uninstall, and modify, is carried out for multiple products with a single action request.

3. The system of claim 2, wherein the installation server database on the first computing device, and the installation server database on the second computing device, each respectively includes an index all product components and the associated information on its respective computing device.

4. The system of claim 3, wherein the associated information of a product component includes: installed, uninstalled, modified, version, and location.

5. The system of claim 4, wherein the installation tool works on the second computing device via at least one of: a hardwire connection, a network, a medium, a CDROM, a DVD, and a flash memory.

6. The system of claim 4, wherein installing a product component on the second computing device includes indexing the product component and associated information on the installation server database of the second computing device.

7. The system of claim 6, wherein before the product component is installed on the second computing device, the installation tool analyzes whether the product component requires another indexed product component in the installation server database of the first computing device, and if necessary, then both the product component and the required indexed product component are installed on the second computing device.

8. The system of claim 4, wherein uninstalling a product component on the second computing device includes un-indexing the product component and associated information on the installation server database of the second computing device.

9. The system of claim 8, wherein before the product component is uninstalled on the second computing device, the installation tool analyzes whether the product component is necessary to another indexed product component in the installation server database of the second computing device, and if necessary, then the product component is not uninstalled.

10. The system of claim 4, wherein modifying a product component on the second computing device includes analyzing the associated version information of the product component on the second computing device, and, if the modification is an updated version, then modifying the product component by copying the product component to the second computing device and updating the associated version information of the product component on the second computing device.

11. The system of claim 4, further comprising a graphical user interface, the graphical user interface displaying a result of a differential analysis of the installation server databases of the first and second computing devices, wherein the result is a listing of the product components available from the first computing device and the product components already installed on the second computing device, wherein the product components belong to one of one software product and multiple software products.

12. The system of claim 11, wherein the graphical user interface allows for a user to select, deselect, and neither select or deselect, displayed product components in the listing on the graphical user interface, so that a selection of at least one displayed product component effects one of an installation and a modifying of the at least one displayed product component on the second computing device, and, a deselection of at least one displayed product component effects an uninstallation of the at least one displayed product component on the second computing device, wherein the at least one displayed product component is from at least one software product.

13. The system of claim 12, wherein the user can select, deselect, and neither select or deselect via at least one of a list, a checklist, balloons, buttons, and dialog.

14. The system of claim 12, wherein the first computing device is at least one of a distribution server, an installation server, a computer, a handheld computing device, a medium, a network site, multiple computing resources, a DVD, a CDROM, and a flash memory; and the second computing device is at least one of a user workstation, a computer, a handheld computing device, a medium, a network site, multiple computing resources, a DVD, a CDROM, and a flash memory.

15. A method for single action installing, uninstalling, and/or modifying a software product, comprising:
providing a first computing device;
providing a second computing device; and
providing an installation tool, the installation tool being located on the first computing device,
wherein in response to a request to do at least one of install, uninstall, and modify, a software product component on the second computing device, executing the installation tool on the second computing device,
reading any installation server databases on the first and second computing devices to determine product components and their associated information, and executing any requests to do at least one of install, uninstall, and modify.

16. The system of claim 15, wherein the request to do at least one of install, uninstall, and modify, is carried out for multiple products.

17. The system of claim 2, wherein the installation server database on the first computing device, and the installation server database on the second computing device, each respectively includes an index all product components and the associated information on its respective computing device, wherein the associated information of a product component includes: installed, uninstalled, modified, version, and location.

18. The system of claim 17, wherein installing a product component on the second computing device includes indexing the product component and associated information on the installation server database of the second computing device.
